(19) United States
(12) Patent Application Publication
(10) Pub. No.: US 2017/0178309 A1
(43) Pub. Date: Jun. 22, 2017

(54) METHODS AND SYSTEMS FOR THE ESTIMATION OF DIFFERENT TYPES OF NOISE IN IMAGE AND VIDEO SIGNALS

(71) Applicant: WRNCH INC., Montreal (CA)

(72) Inventors: Meisam Rakhshanfar, Montreal (CA); Maria Aishy AMER, Montreal (CA)

(21) Appl. No.: 15/311,356

(22) PCT Filed: May 15, 2015
(86) PCT No.: PCT/CA2015/000322

§ 371 Date: Nov. 15, 2016

Related U.S. Application Data
(60) Provisional application No. 61/993,469, filed on May 15, 2014.

(51) Int. Cl. G06T 7/00

(52) U.S. Cl. CPC G06T 7/0002; G06T 2207/30168; G06T 2207/10016; G06T 2207/20021; G06T 2207/10004

(57) ABSTRACT

A method is provided to estimate image and video noise of different types: white Gaussian (signal-independent), mixed Poissonian-Gaussian (signal-dependent), or processed (non-white). Our method also estimates the noise level function (NLF) of these noises. This is done by classification of intensity variances of image patches in order to find homogeneous regions that best represent the noise. It is assumed that the noise variance is a piecewise linear function of intensity in each intensity class. To find noise representative regions, noisy (signal-free) patches are first nominated in each intensity class. Next, clusters of connected patches are weighted where the weights are calculated based on the degree of similarity to the noise model. The highest ranked cluster defines the peak noise variance and other selected Ousters are used to approximate the NLF.

### RELATED APPLICATIONS

This application claims priority to U.S. Patent Application No. 61/993,469, filed May 15, 2014, titled “Method and System for the Estimation of Different Types of Noise in image and Video Signals”, the entire contents of which are hereby incorporated by reference.

### TECHNICAL FIELD

The present invention relates generally to image and video noise analysis and specifically to a method and system for estimating different types of noise in image and video signals.

### BACKGROUND

Noise measurement is an essential component of many image and video processing techniques (e.g., noise reduction, compression, and object segmentation), as adapting their parameters to the existing noise level can significantly improve their accuracy. Noise is added to the images or video from different sources [References 1-3] such as CCD sensor (fixed pattern noise, dark current noise, shot noise, and amplifier noise), post-filtering (processed noise), and compression (quantization noise).

Noise is signal-dependent due to physical properties of sensors and frequency-dependent due to post-capture filtering or Bayer interpolation in digital cameras. Thus, image and video noise is classified into: additive white Gaussian noise (AWGN) that is both frequency and signal independent, Poissonian-Gaussian noise (PGN) that is frequency independent but signal-dependent, i.e., AWGN for a certain intensity, and processed Poissonian-Gaussian noise (PPN) that is both frequency and signal dependent, non-white Gaussian for a particular intensity.

Many noise estimation approaches assume the noise is Gaussian, which is not accurate in practical video applications, where video noise is signal-dependent. Techniques that estimate signal-dependent noise, on the other hand, do not handle Gaussian noise. Furthermore, noise estimation approaches rely on the assumption that high frequency components of the noise exist, which makes them fail in real-world non-white, (processed) noise. This is even more problematic in approaches using small patches (e.g., 5×5 pixels) [References 4-9] because the probability to find a small patch with a variance much less than the noise power is higher than in large patch.

### BRIEF DESCRIPTION OF THE DRAWINGS

Embodiments of the invention or inventions are described, by way of example only, with reference to the appended drawings wherein:

FIG. 1 is an example embodiment of a computing system and modules for an imaging pipeline.

FIGS. 2(a) and 2(b) are examples of images captured with the same camera in a raw mode and in a processed mode respectively, FIGS. 2(c) and 2(d) show the average of noise frequency magnitudes of 35 different images taken by 7 cameras in a raw mode and in a processed mode, respectively.

FIGS. 3(a) and 3(b) respectively show example noise level function (NLF) approximations for two sample images and their corresponding NLF in RGB channels. FIG. 3(c) show a piecewise linear modeling of NLF.

FIG. 4 is an intra-frame block diagram of the estimator operating spatially within one image or video frame.

FIG. 5 is an inter frame and intra-frame block diagram of the estimator operating spatio-temporal in a video signal.

FIG. 6 is an example image showing different intensity classes of target patches and the corresponding connectivity.

FIG. 7 is an example image showing selected weighted clusters in different intensity classes.

FIG. 8 is an example graph showing low-to-high frequency power ratios of homogeneous re-ions in raw and processed images taken by 7 different cameras.

FIG. 9(a) is an example graph showing a relation between the filter strength and low-to-high average frequency power ration. FIG. 9(b) is an example graph showing linear approximation using the low-to-high ration.

FIG. 10 is an example graph of an NLF approximation.

FIG. 11 is a set of 14 test images for an additive white Gaussian noise (AWGN) test.

FIGS. 12(a) and (b) are example images used in homogeneity selection under AWGN.

FIG. 13 is an example graph showing stability of the proposed method in video signal under AWGN with and without temporal weights.

FIG. 14 shows examples of 7 real-world test images.

FIG. 15(a) and 15(b) are examples of homogeneity selection for real Poissonian-Gaussian noise (PGN).

FIGS. 16(a)-16(e) are a set noise removal examples using BM3D, FIG. 16(a) are original images. FIG. 16(b) shows images processed using noise estimated according to [Reference 7]. FIG. 16(c) shows images processed using noise estimated according to IVHC.

FIG. 17 is an example graph showing MetricQ of real noise removal using different noise estimators for In-to-tree sequence.

FIG. 18 is an example graph showing processed synthetic noise in a video in peak signal-to-noise ratio (PSNR).

FIGS. 19(a) to 19(d) are a set noise removal examples using BM3D.

FIGS. 20(a)-20(d) are example graphs of estimated NLFs with respect to SRx100II, Intotree, Salpha77, and Sintel.

FIG. 21 is a table showing example results for averages of absolute errors using test images in FIG. 11.

FIG. 22 is a table of MetricQ comparison of PGN removal.

FIG. 23 is a table of real-world processed noised removal results according to average MetricQ using BM3D.

FIG. 24 is a table of root mean square error (RMSE) values and maximum values of error of NLF in noise images.

FIG. 25 is a table of the average of elapsed time to process the test images.

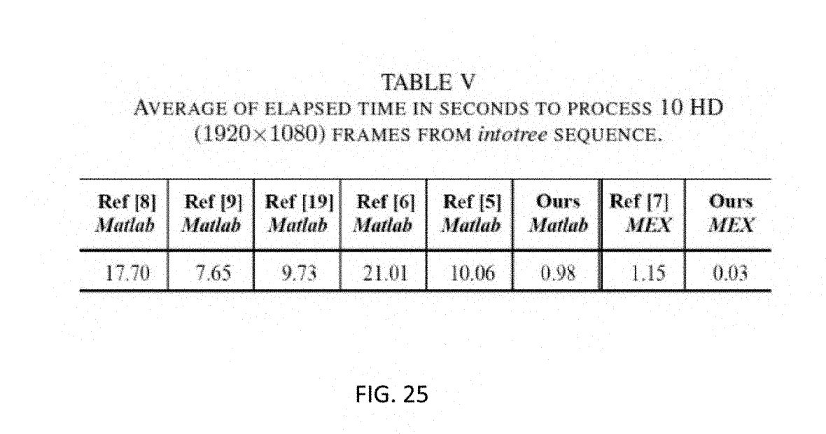

### DETAILED DESCRIPTION

It will he appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

A method and a system are provided for the estimation of different types of noise in images and video signals using preferably, intensity-variance homogeneity classification will be described herein.

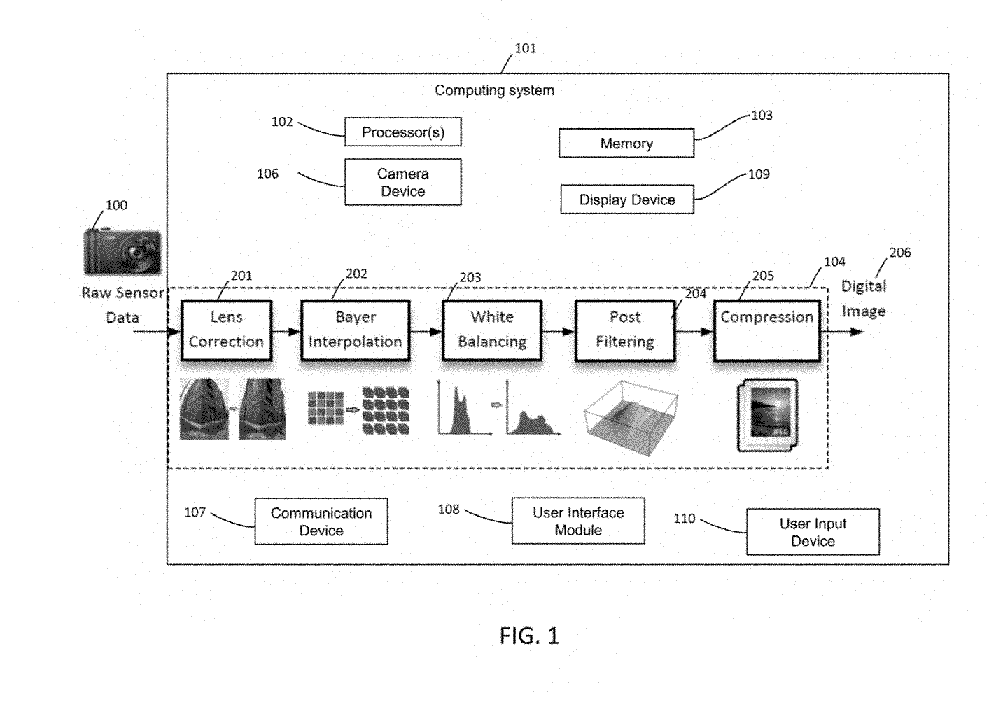

FIG. 1 is an example embodiment of a computing system 101 with components for a CCD (charge-coupled device) camera pipeline. The computing system 101 includes a processor 102, memory 103 for storing images and executable instructions, and an image processing module 104.

The computing system 101 may also include a camera device 106, or may be in data communication with CCD or camera device 100. In an example embodiment, the computing system also includes, though not necessarily, a communication device 107, a user interface module 108, and a user input device 110.

Throughout this sensing pipeline as best seen by module 104, noise is added to the image from different sources, including but not limited to a CCD sensor, creating noises such as fixed pattern noise, dark current noise, shot noise, and amplifier noise, post filtering (processed non-white noise), and compression (quantization noise), which render a digital image 206. Referring to FIG. 1, raw sensor data is collected and passes through lens correction 201. The lens corrected data then undergoes Bayer interpolation 202, white balancing 203 post filtering 204 and finally compression 205 before being rendered as a digital image 206.

In a non-limiting example embodiment, the computing system may be a consumer electronic device, such as a camera device. In other words, the electronic device may include a physical body to house the components. Alternatively, the computing system is a computing device that is provided with image or video feed, or both.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing system 101, or accessible Or connectable thereto. Any application or module herein described may be implemented using computer readable/executable instructions or operations that may be stored or otherwise held by such computer readable media.

The proposed systems and methods are configured to perform one or more of the following functions:
operate on a still image or a video signal;
operate on gray-scale as well as color image or video;
estimate the noise variance of AWGN, PGN, and PPN automatically;
estimate the noise level function (NLF), e.g., the relation between the noise variance and the intensities of the input noisy signal;
temporally stabilize the current estimate using estimates from previous frames;
differentiate noise from image structure by relating the input noisy signal and its down-sampled version;
adapt the patch size for intensity classification using both the input noisy signal and its down-sampled version;
rank noise representative regions (clusters) based on intra-image (spatial) features including intensity, spatial relation (connectivity and neighborhood dependency), low-high frequency relation, size, and margins;
rank noise representative regions based on inter-image (temporal) features including temporal difference between patch signal in neighboring frames and difference between current estimate and estimates from previous frames;
rank noise representative regions based on camera and capture settings, if they are available as metadata and
rank noise representative regions based on manual user input in offline applications such as post production.

These features extend beyond [Reference 10], as the proposed systems and methods additionally a) estimate both the noise variance and the NLF; b) estimate both processed and unprocessed noise; and c) broadens the solution by adding many new features such as using temporal data. As a result, the performance significantly improved compared to [Reference 10].

1. Noise Modeling

1.1 White Noise

The input noisy video frame (or still image) I can be modeled as, I=I_{org}+n_{d}+n_{g}+n_{q}, where I_{org} represents the noise-free image, n_{d} represents white signal-dependent noise, n_{g} represents white signal-independent noise, and n_{q} represents quantization and amplification noise. With modern camera technology and n_{q} can be ignored since it is very small compared to nₒ=n_{d}+n_{g}, n_{d} and n_{g} are assumed zero-mean random variables with variance σ_{d}² (I) and σ_{g}², respectively. (For simplicity of notation, the symbol I is herein used to refer to either a whole image or to an intensity of that image; this will be clear from the context.) The NLF of the image intensity I can be assumed,

σ²(I)=σ_{d}²(I)+σ_{g}² (1)

The computing system defines σₒ²=max (σ²(I)) as the peak σ²(I). When a video application, e,g., motion detection, requires a single noise variance, the best descriptive value is the maximum level, since a boundary can be effectively designated to discriminate between signal and noise. In (15), the computing system estimates σₚ² as the peak of the level function of the observed video noise, which can be AWGN, PGN, or PPN. Under PGN, the peak variance is σₒ² which becomes σₚ² as estimated in (15); under PPN, the peak variance σₐ² is estimated from σₚ² using (2).

1.2 Processed Noise

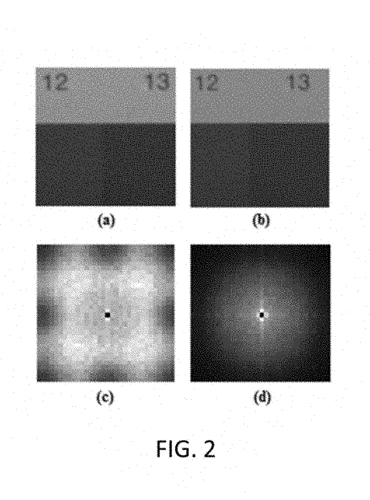

Processing technologies such as Beyer pattern interpolation, noise removal, bit-rate reduction, and resolution enlargement, are being increasingly embedded in digital cameras. For example, spatial filtering is used to decrease the bit-rate. Accurate data about in camera processing is not available, in many cameras, however, processing call be bypassed manually, which allows to explore statistical properties of noise before and after processing. Experiments show that the low-power high frequency components of the noise (compared to noise power) are eliminated. As a result, low frequency and impulse shaped noise remains. FIG. 2 shows parts of two images taken under the same condition in raw and processed image mode. This figure also shows the frequency spectrum of noise in both modes. The noise was studied using homogeneous image regions that were manually selected from 35 images taken by 7 different cameras (e.g. Canon EOS 6D, Fujifilm ×100, Nikon D700, Olympus E-5, Panasonic LX7, Samsung NX200, Sony RX100). As can be seen, filtering, changes the frequency spectrum of the noise and makes it processed (e.g. frequency dependent). In many video processing applications, estimation of the noise level before the in-camera filtering is desirable for accurate processing. It is herein recognized that such estimation is challenging since some of noise frequency components are removed and calculation of the pre-processing (original) noise level by its current power (e.g., variance of homogeneous patches) is no longer accurate.

When PGN becomes processed, the resulting noisy image cap be modeled as I^{p}=I_{org}+nₚ with nₚ as the PPN and peak variance σₚ². The before in-camera processing image I is modeled as I=I^{p}+n_{γ} with n_{γ} as the distortion noise and peak variance σ_{γ}². The method thus differentiates here between PGN nₒ, PPN nₚ, and distortion noise n_{γ}, where nₒ=nₚ+n_{γ}. Let 1≦γ≦γₘₐₓ be the degree (power) of processing on σₒ². The method estimates,

σₒ²=γ·σₚ². (2)

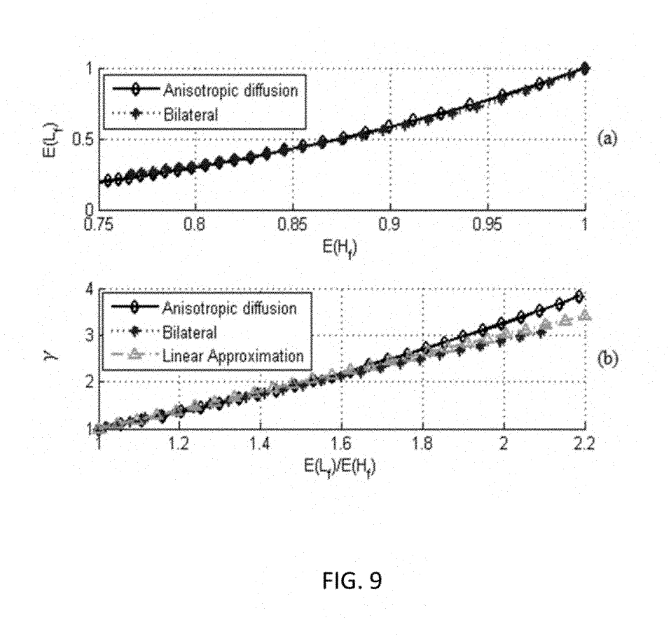

γ=1 means the observed noise is PGN; γ=γₘₐₓ means I was not heavily processed, as shown in FIG. 9. Heavily processed means the nature of PGN was heavily changed resulting in large σ_{γ}² compared σₚ², i.e., σ_{γ}²>>σₚ² since the mean absolute difference of I and I^{p} is large.

1.3 Noise Level Function

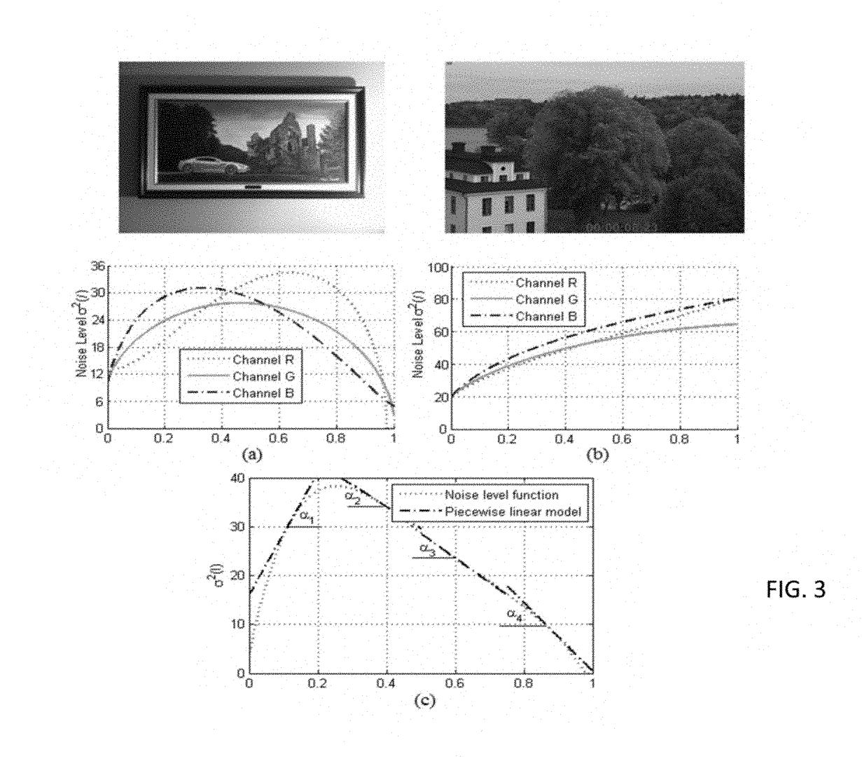

A better adaptation of video processing applications to noise can be achieved by considering the NLF instead of a single value. It is herein recognized however, that there is no guarantee that pure noise (signal-free) pixels are available for all intensities, and thus NLF estimation is challenging. The NLF strongly depends on camera and capture settings [Reference 11] as illustrated in FIG. 3

Assume the computing system divides the intensity range of the input noisy image I into M sub-intensity classes. A piecewise linear function, see FIG. 3(c), can approximate the NLF in intensity class I as follow,

σₗ²(I)=αₗ*σᵣₑₚ_{ₗ}²(I−Iᵣₑₚ_{ₗ})+σᵣₑₚ_{ₗ}²=(αₗ(I−Iᵣₑₚ_{ₗ})+1)*σᵣₑₚ_{ₗ}² (3)

where l∈{1, . . . , M}, I∈{I^{l}^{^{min}}, I^{l}^{^{max}}}, I^{l}^{^{min}} and I^{l}^{^{max}} define the intensity class boundaries, σᵣₑₚ_{₁}² represents a point of σₗ² (1) and Iᵣₑₚ_{₁} is its corresponding Intensity. σᵣₑₚ_{₁}² is, for example, the median of σₗ² (I). α₁ in (3) represents the slope of a line approximating the NLF in the intensity class 1 as illustrated in FIG. 3. If M is appropriately selected (not too many nor too few classes), α₁ will not exceed αₘₐₓ≧max(|α₁|). The computing system uses αₘₐₓ, to locate patches that fit into linear model of the NLF, Equation (3) states that given σᵣₑₚ² and |α₁|≦αₘₐₓ, then σₗ²(I)≦σₘₐₓ₁², where σ_{maxI}²=σᵣₑₚ²αₘₐₓ,×max(|I−Iᵣₑₚ₁|)+σᵣₑₚ₁², meaning, by having M (where max(|I−Iᵣₑₚ₁|)=1/M) and σᵣₑₚ₁² computing system can reject non-homogeneous patches that their variances are greater than σₘₐₓ₁². This can thus be used to target homogeneous patches, as shown below.

2. State-of-the-art

AWN estimation techniques can be categorized into filter-based, transform-based, edge-based, and patch-based methods. Filter-based techniques [Reference 12], [Reference 13] first smooth the image using a spatial filter and then estimate the noise from the difference between the noisy and smoothed images. In such methods, spatial filters are designed based on parameters that represent the image noise. Transform (wavelet or DCT) based methods [References 14-20] extract the noise from the diagonal band coefficients. [Reference 19] proposed a statistical approach to analyze the DCT filtered image and suggested that the change in kurtosis values results from the input noise. They proposed a model using this effect to estimate the noise level in real-world images. It is herein recognized that although the global processing makes transform-based methods robust, their edge-noise differentiation load to inaccuracy in low noise levels or high structured images.

[Reference 19] aims to solve this problem by applying a block-based transform. [Reference 20] uses self-similarity of image blocks, where similar blocks are represented in 3D form via a 3D DCT transform. The noise variance is estimated from high-frequency components assuming image structure is concentrated in low frequencies. Edge-based methods [Reference 11, Reference 21, Reference 22] select homogeneous segments via edge-detection. In patch-based methods References [6-9], noise estimation relies on identifying pure noise patches (usually blocks) and averaging the patch variances.

Overall local methods that deal with subsets of images (i.e. homogeneous segments or patches) are more accurate, since they exclude image structures more efficiently, [Reference 6] utilizes local and global data to increase robustness, in [Reference 7], a threshold adaptive Sobel edge detection selects the target patches, then averages of the convolutions over the selected blocks to provide accurate estimation of noise variance. Based on principal component analysis [Reference 8] first finds the smallest eigenvalue of the image block covariance matrix and then estimates the noise variance. Gradient covariance matrix is used in [Reference 9] to select “weak” textured patches through an iterative process estimate the noise variance.

It is herein recognized that patch size is critical for patch-based methods. A smaller patch is better for low level of the noise, while, larger patch makes the estimation more accurate in higher noise level. For all patch sizes, estimation is error prone under processed noise; however by taking more low frequency components into account, larger patches are less erroneous. By adapting the patch size in these estimators to image resolution, it is more likely to find noisy (signal-free) patches, which consequently increases the performance. Logically finding image subsets with lower energy under AWGN conditions leads to accurate results. However, under PGN conditions underestimation normally occurs. Under AWGN, [References 7-9] outperform others, however, it is herein recognized that noise underestimation in PGN makes them impractical for real-world applications.

PGN estimation methods express the noise as a function of image brightness. The main focuses of related work is to first simplify the variance-intensity function and second to estimate the function parameters using many candidates as fitting points. In [Reference 4], [Reference 23], the NLF is defined as a linear function σ² (I)=α1+b and the goal is to estimate the constants a and b. Wavelet domain [Reference 4] and DCT [Reference 23] analysis are used to localize the smooth regions. Based on the variance of selected regions, each point of curve is considered to perform the maximum likelihood fitting. [Reference 24] estimates noise variation parameters using maximum likelihood estimator. It is herein recognized that this iterative procedure brings up the initial value selection and convergence problems. The same idea is applied in [Reference 11] by using a piecewise smooth image model.

After image segmentation, the estimated variance of each segment is considered as an overestimate of the noise level. Then the lower envelope variance samples versus mean of each segment is computed and based on that, the noise level function by a curve fitting is calculated. In [Reference 25], particle filters are used as a structure analyzer to detect homogeneous blocks, which are grouped to estimate noise levels for various image intensities with confidences. Then, the noise level function is estimated from the incomplete and noisy estimated samples by solving its sparse representation under a trained basis. The curve fitting using many variance-intensity pairs, requires enormous computations, which is not practical for many application especially when the curve estimation is needed to be presented as a single value. As a special case of PGN with zero dependency, AWGN cases are not examined in these NLF estimation methods. In [Reference 26], a variance stabilization transform (VST) converts the properties of the noise into AWGN. Instead of processing the Gaussianized image and inverting back to Poisson model, a Poisson denoising method is applied to avoid an inverted VST.

PPN is not yet an active research and few estimation methods exist. In [Reference 27], first, candidate patches are selected using their gradient energy. Then, the 3D Fourier analysis of current frame and other motion-compensated frames is used to estimate the amplitude of noise. A wider assumption is in [Reference 28] by considering both frequency and signal dependency. In this method, the similarity between patches and neighborhood is the criterion to differentiate the noise and image structure. Using the exhaustive search, candidate patches are selected and noise is estimated in each DCT coefficient.

3. Proposed Systems and methods

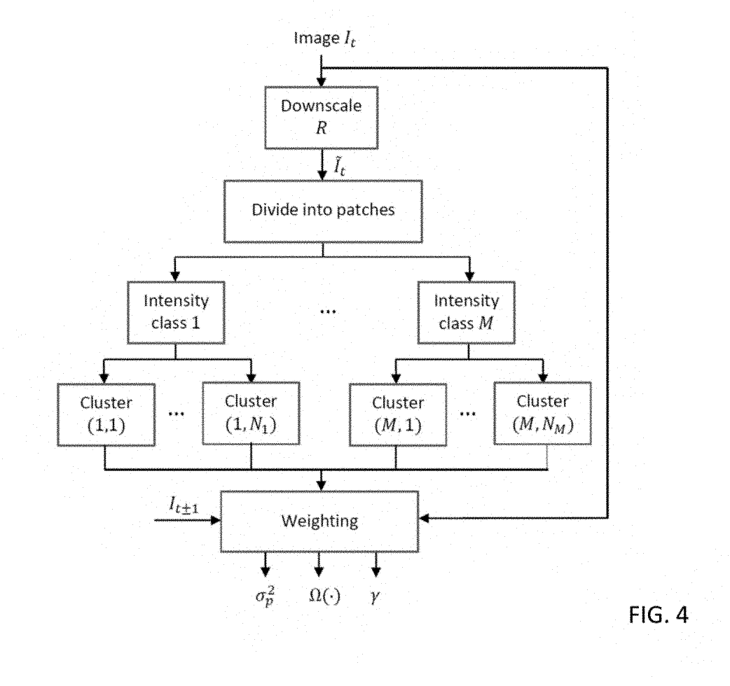

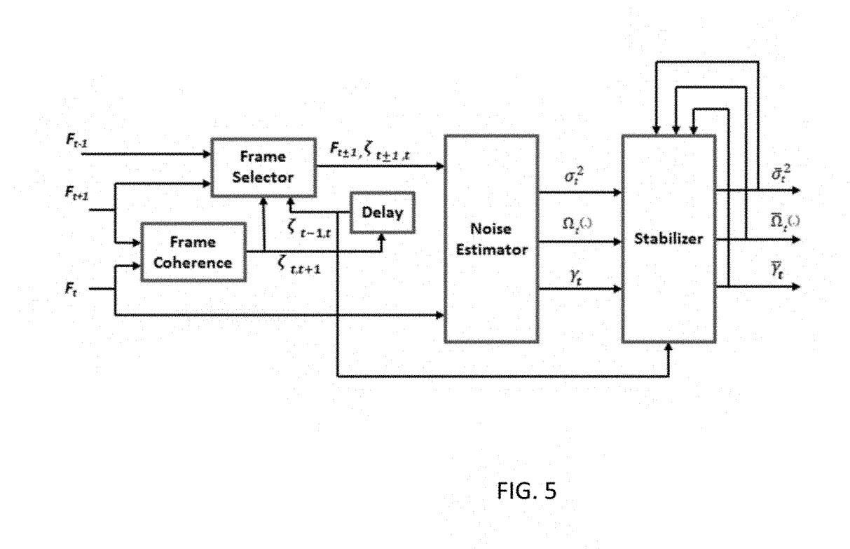

The proposed systems and methods are based on the classification of intensity-variances of signal patches (blocks) in order to find homogeneous regions that best represent the noise. It is assumes that noise variance is linear, with limited slope, to the intensity in a class. To find homogeneous regions, the method works on the down-sampled input image and divides it into patches. Each patch is assigned to an intensity class, whereas outlier patches are rejected. Clusters of connected patches in each class are formed and some weights are assigned to them. Then, the most homogeneous cluster is selected and the mean variance of patches of this cluster is considered as the noise variance peak of the input noisy signal. To account for processed noise, an adjustment procedure is proposed based on the ratio of low to high frequency energies. To account for noise variations along video signals, a temporal stabilization of the estimated noise is proposed. The block diagram in FIG. 4 shows how the proposed method estimates the noise within one image or video frame without temporal considerations. FIG. 5 shows how the method is stabilized using temporal processing in video. The proposed noise estimation based on intensity variance homogeneity classification (IVHC) can be summarized as in Algorithm 1. In the remainder of this section, a discussion of the following is included: building homogeneous patches; classifying patches; building clusters of connected patches and estimating the noise peak variance; estimating parameters of processed noise; approximating the NLF; temporally stabilizing the estimate; computing intra-frame and inter-frame weights; adapting to camera settings; and showing how to adapt the method to user input in offline applications.

Algorithm 1: IVHC based noise estimation

| | |
|---|---|
| i) | Downscale the image I to I & divide I into patches: (7). |
| ii) | Assign each patch a class number: (6). |
| iii) | Find the target connected clusters in each class in Ī: (8). |
| iv) | Find the corresponding cluster \hat{Φ}(l, k) in I and |
| | remove outliers: (11). |
| v) | Calculate weights for the clusters: ω₁(l, k) . . . ω₁₁(l, k) |
| vi) | Find the noise-representative cluster \hat{Φ}: (14). |
| vii) | Compute the noise variance σₚ² of selected cluster \hat{Φ}: (15). |
| viii) | Estimate the noise level function Ω(.): (18). |
| ix) | Estimate the in-camera processing degree γ: (17). |
| x) | Stabilize the estimates σₚ², Ω(.), and γ temporally: (19). |

3.1 Homogeneity Guided Patches

Homogeneous patches are image blocks \tilde{B}ᵢ of a size W×W,

$${B}_{i} = \{ I ( x , y ) \vert x , y ∈ {P}_{i} \} , \\ {P}_{i} \{ ( x , y ) \vert \frac{i}{r} \leq x \leq \frac{i}{r} + W - 1 , mod ( i , r ) \leq y \leq mod ( i , r ) + W - 1 \} , \qquad ( 4 )$$

where Ĩ(x, y) is the down-sampled version of the input noisy image at the spatial location (x,y), mod( ) is the modulus after division, and r is the image height (number of rows). After decomposing the image into non-overlapped patches, the noise nᵢ of each patch can be described as Bᵢ=Zᵢ+nᵢ where \tilde{B}ᵢ is the observed patch corrupted by independent and identically-distributed (i.i.d) zero-mean Gaussian noise nᵢ and Zᵢ is the original non-noisy image patch. The variance σ²(\tilde{B}ᵢ) a patch represents the level of homogeneity \tilde{H}ᵢ of \tilde{B}ᵢ,

$${\tilde{H}}_{i} = {σ}^{2} ( {\tilde{B}}_{i} ) = \frac{\sum ( {\tilde{B}}_{i} - μ ( {\tilde{B}}_{i} ) ) 2}{{W}^{2} - 1} ; \\ μ ( {\tilde{B}}_{i} ) = \frac{\sum ( {\tilde{B}}_{i} )}{{W}^{2}} \qquad ( 5 )$$

A small \tilde{H}ᵢ expresses high patch homogeneity. Under PUN conditions, noise is i.i.d for each intensity level. If an image is classified into classes of patches with same intensity level, the \tilde{H}ᵢ homogeneity model can be applied to each class. Assuming M intensity classes, \tilde{L}₁ represents the patches of the lth intensity class,

\tilde{L}ₗ={\tilde{B}ᵢ|Iₗ^{min}≦μ(\tilde{B}ᵢ)≦Iₗ^{max}|}, l ∈{1:M} (6)

For M=4, I₁^{min}={0; 0.17; 0.4; 0.82} and Iₗ^{max}={0.2; 0.45; 0.84; 1} are vectors defining lower and upper hounds of class intensity.

3.2 Adaptive Patch Classification

Images contain statistically more low frequencies than high frequencies. But small image patches show more high frequencies than low frequencies. Thus small patches have the advantage better signal-noise differentiation. Large image patches, on the other side, are less likely to fall in the local minima especially when noise is processed. To benefit from both, the computing systems uses image downscaling with rate R with a coarse averaging as the anti-aliasing filter,

$$\tilde{I} ( x , y ) = \frac{1}{{R}^{2}} {\sum }_{i , j = 0}^{R - 1} I ( xR + i , yR + j ) \qquad ( 7 )$$

where I and Ĩ are the observed and down-sampled images. This gives small patches in Ī and large patches in I. Furthermore, the processed noise converges to white in the downscaled image. Other desirable effects of downscaling are: 1) noise estimation parameters can he fixed for a lowest possible resolution of the images (note that R varies depending on the input image resolution) and 2) since the down-scaled image contains more low frequencies, the signal to noise ratio is higher. Assuming \tilde{L} represents the set of patches in Ĩ; the computing system binary classifies the patches of the lth intensity class in Ĩ into \tilde{L}₁={\tilde{L}₁⁰, Lₗ¹}, where \tilde{L}₁ are the target patches as in,

\tilde{L}ₗ¹={\tilde{B}ᵢ|\tilde{H}ᵢ≦\tilde{H}ₜₕ(l), \tilde{B}ᵢ ∈ \tilde{L}ᵢ} (8)

It uses the homogeneity values \tilde{H}ᵢ and a threshold value \tilde{H}ₜₕ(l) to binary classify \tilde{L}ₗ. Assuming the maximum value of the slopes α_{]}of the NLF in (3) is αₘₐₓ. We define \tilde{H}ₜₕ(1) as,

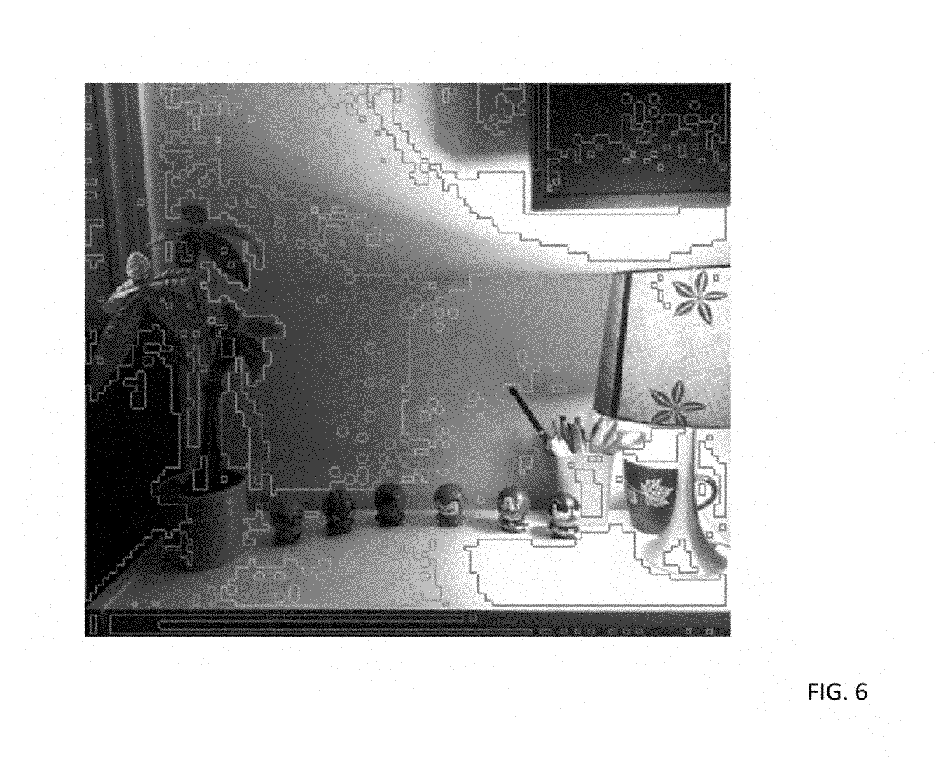

\tilde{H}ₜₕ(1)=αₘₐₓ\tilde{H}_{med}(l)+β (9)

where β=1 and αmax=3. To calculate \tilde{H}_{med}(1), the computing system first divides \tilde{L}_{I} into three sub-classes, then finds the minimum \tilde{H}ᵢ in each sub-class and finally finds the median of the three values. When class l contains overexposed or underexposed patches, \tilde{H}_{med}(l) becomes very small. Therefore, the offset β is considered to include noisy patches. FIG. 6 shows sample target patches and their connectivity with M=4. Spatial information from horizontal and vertical connectivity can be used to form patch clusters as explained next.

3.3 Cluster Selection and Peak Variance Estimation

Due to complexity of noise and image structure, the variance based classification (8) by itself does not describe the noise in the image. In addition to statistical analysis, the computing system uses a spatial analysis to extract a more reliable noise descriptor. The computing system uses connectivity of patches in both horizontal and vertical directions to form clusters of similar patches. Next, for each cluster of connected patches in the down-sampled image Ĩ, the computing system first finds the corresponding connected patches Bᵢ (with size of R·W×R·W) from the cluster \ddot{Φ} (l, k) in the input noisy image I and then eliminate the outliers of cluster based on their mean and variance. Finally, the computing system assesses each cluster (after outlier removal) based on the intra- and inter-frame weights ω₁ to ω₁₁, \ddot{Φ} (l, k) represents the kth cluster of connected patches in the class l before outlier removal.

3.3.1 Outlier Removal

The removal of outliers in each cluster is based on Euclidean distance of both the mean and the variance. For each cluster the patch with higher probability of homogeneity is defined as the reference patch and patches out of certain Euclidean distance are removed. Assuming \ddot{Φ} (l, k) represents the kth cluster of connected patches in the class l before outlier removal, the computing system defines the reference value of variance and mean of each cluster as,

$${σ}_{ref}^{2} ( l , k ) = min \{ {σ}_{{B}_{i}}^{2} \} , \\ {μ}_{ref} ( l , k ) = mean [ {B}_{ref} ( l , k ) ] , \\ {B}_{ref} ( l , k ) = arg {min}_{{B}_{i} ∈ \ddot{Φ} ( l , k )} \{ {σ}_{{B}_{i}}^{2} \} \qquad ( 10 )$$

where B_{ref} (l, k) is the patch with the minimum variance in \ddot{Φ} (l, k) and its variance σ_{ref}² (l, k) and mean μ_{ref} (l, k) are considered references. By defining two intervals using two thresholds, the cluster after outlier removal is,

Φ(l, k)={Bᵢ∥σ_{B}_{ᵢ}²−σ_{ref}²(l, k)≦t_{σ}(l, k) [symbol] |μ_{B}_{ᵢ}−μ_{ref}(l, k)|≦t_{μ}(l, k) [symbol] Bᵢ ∈ \ddot{Φ}(l, k)} (11)

where t^{σ} (l, k) and t_{μ}(l, k) are the variance and the mean thresholds that are directly proportional to σ^{ref}^{²} (l, k) as,

$${t}_{σ} ( l , k ) = {C}_{σ} * {σ}_{ref}^{2} ( l , k ) ; {t}_{μ} ( l , k ) = {C}_{μ} * \frac{{σ}_{ref} ( l , k )}{R \cdot W} \qquad ( 12 )$$

Where C^{σ}=3 and C^{p}=4.

To avoid including image structure in the clusters, the similarity of the patches is considered and in (12) we replace σ_{ref}² (l, k) with σₛᵢₘ² (l, k) defined as,

$${σ}_{sim}^{2} ( l , k ) = \frac{min [ {( {B}_{i} - {B}_{j} )}^{2} ]}{2} , \\ {B}_{i} , {B}_{j} ∈ \ddot{Φ} ( l , k ) , i \neq j \qquad ( 13 )$$

33.2 Cluster Ranking

For each outlier-reduced connected cluster Φ (l, k) the computing system first computes the weights wⱼ (l, k) and then selects the final homogeneous cluster \hat{Φ} as in,

$$\hat{Φ} = \begin{matrix}arg max & \\ Φ ( l , k ) & ( {\sum }_{j = 1}^{11} {w}_{j} ( l , k ) )\end{matrix} \qquad ( 14 )$$

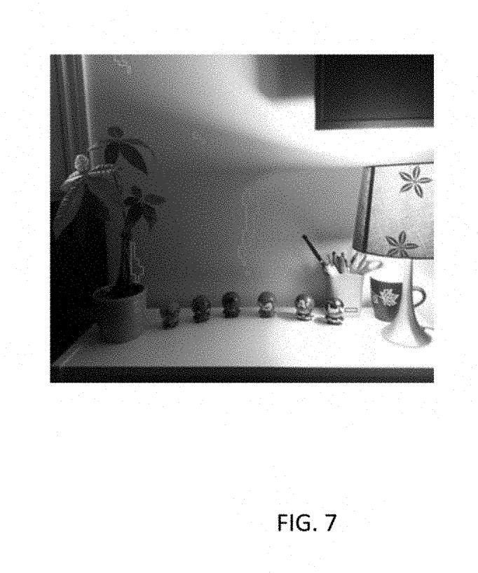

Then the computing system defines the peak noise level σₚ² in the input image as the average of the patch variances in \hat{Φ} the cluster ranked highest, e.g., best represents random noise,

$${σ}_{p}^{2} = \frac{{Σσ}_{{B}_{i}}^{2}}{N \{ \hat{Φ} \}} , {B}_{i} ∈ \hat{Φ} \qquad ( 15 )$$

where M{\hat{Φ}} is the number of patches in the cluster \hat{Φ}. The value σₚ² is considered as the peak variance because the computing system gives higher weights to cluster with higher variances. Estimates of {0≦ωⱼ(l, k)≦1} are proposed in the below, where it considers noise in both low and high frequencies, size of the cluster, patch variances, intensity and variance margins, maximum noise level, clipping factors, temporal error, and previous estimates. FIG. 7 shows selected weighted clusters in different intensity classes.

3.4 Processed Noise Estimation

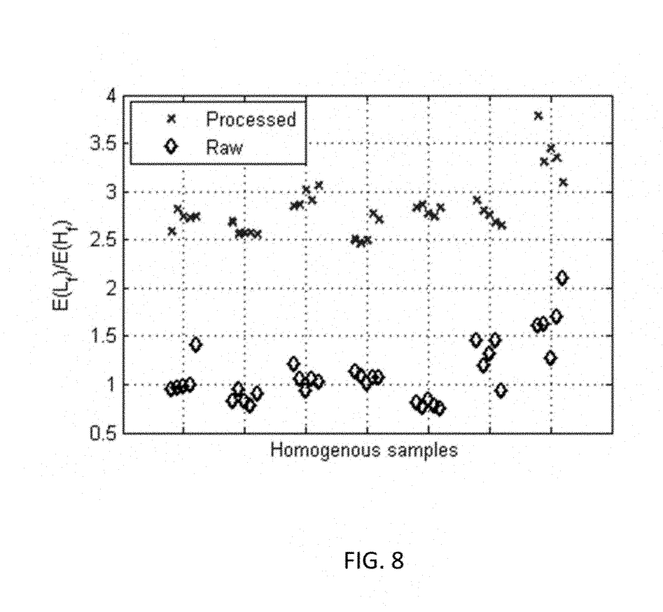

It is herein recognized that the assumption that the noise is frequency-independent in each homogeneous cluster is incorrect in processed images. In such situations, the variance of selected cluster σₚ² (15) does not represent the true level of the noise in the unprocessed noisy image because some frequency components of the noise have been removed. In many applications such as enhancement, the level of the unprocessed (original) noise is required. To estimate this original noise, the relation between low and high frequency components is necessary to trace the deviation from whiteness because the computing system assumes that the degree of noise removal in high frequency and low frequency is different. Let E(L_{f}) represent the variance of low-pass filtered pixels of φ (l, k). The and E(H_{f}) represent the median of the power of high-pass filtered pixels of Φ (l, k). The computing system estimates their relation as follows,

$${E}_{r} = \frac{E ( {L}_{f} )}{E ( {H}_{f} )} = \frac{{C}_{e} \cdot Var ( {h}_{lp} ⋆ Φ ( l , k )}{Median \{ {\vert {h}_{hp} ⋆ Φ ( l , k ) \vert}^{2} \}} \qquad ( 16 )$$

where * is convolution, hₗₚ is a 3×3 moving average filter, and hₕₚ=I−hₗₚ the high-pass filter with a 3 kernel of zero elements except the center is one. With the given low-pass filter Cₑ=3.7. The ratio E^{f} increases with spatial filtering occurs. The computing system selects E(H_{f}) as the median energy because high-frequency noise after filtering has an impulse shape and is divided into high and low levels. In many cameras, the filtering process is optional, allowing for study of the effect of this filtering on processed noise. FIG. 8 shows the low-to-high ratio of homogeneous regions in different raw and processed images. The more noise deviates from whiteness, the higher Eᵣ becomes.

To approximate the processing degree γ of (2), the effect of applying anisotropic diffusion [Reference 29] and bilateral filters [Reference 30] on synthetic AWGN is considered. FIG. 9 shows the relation between E(L_{f}) and E(H_{f}) and how Er relates to γ. It is herein therefore proposed to use linear approximation of a function of Eᵣ as in,

γ=1.4Eᵣ (17)

The computing system temporally stabilizes γ using the procedure discussed in section 3.6. As can be seen in FIG. 9(b) at γ≈3.5, the approximation becomes less accurate.

3.5 Noise Level Function Approximation

The computing system estimates the NLF based on the peak noise variance σₚ² of the selected cluster \hat{Φ} defined in (15) and employs other outlier-removed clusters Φ (l, k) to approximate the NLF. First, the computing system sets all the initial NLF curve \hat{Ω} (.) to σₚ², which means the noise level is identical in all intensities (Gaussian). Then, the computing system updates the \hat{Ω} (.) based on N{Φ (l, k)} the size (i.e., number of patches) and on σ² (l, k) the average of the variances of cluster Φ(l, k). The computing, system assigns a weight (confidence) λ (l, k) to σ² (l, k): the larger N{Φ (l, k)} is, the better σ² (l, k) represents the noise at intensity μ (l, k), meaning the closer λ (l, k) should be to 1. The point-wise NLF \hat{Ω} (.) is then,

$$\begin{matrix}\hat{Ω} ( μ ( l , k ) ) = min ( {σ}_{p}^{2} , \frac{1}{λ ( l , k )} \cdot {σ}^{2} ( l , k ) ) \\ λ ( l , k ) = 1 - exp ( - \frac{N ( Φ ( l , k ) )}{5} ) .\end{matrix} \qquad ( 18 )$$

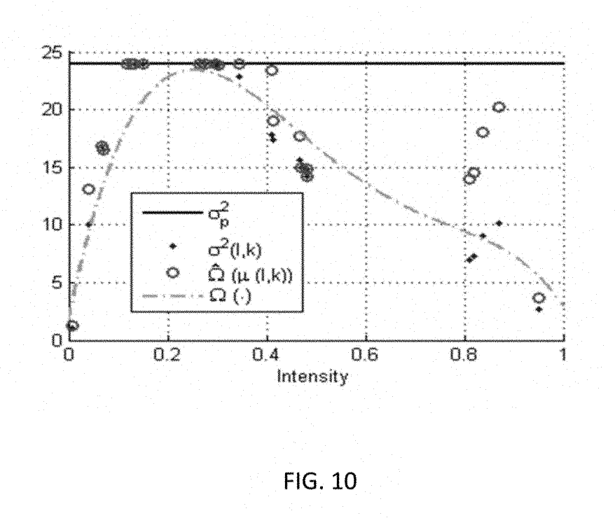

The divisor constant 5 is considered according to 3σ rule by considering that a cluster with 15 (or more patches is completely reliable i.e., λ (l, k)=1. By applying a regression analysis, e.g., curve fitting, the continuous NLF Ω (.) can be approximated from \hat{Ω} (.) as illustrated in FIG. 10 using polyfit of Matlab. In case of AWGN, \hat{Ω} (μ(l, k)) constant equal to σₚ². When PGN gets processed the NLF points are reduced by factor γ but the normalized NLF shape is not altered. Thus, by having the σₒ²=γ·σₚ² as in (2) under PGN of each cluster, the proposed method can estimate the NLF whether the noise is processed or white.

3.6 Temporal Stabilization of Estimates

In many video applications, instability of noise level is intolerable, unless the temporal coherence between frame is very small e.g., a scene change. Let ζ_{t-1,t} represent the similarity between the current Iᵢ and previous frame Iₜ₋₁0≦ζ_{t-1,t}≦1. ζ determines how the statistical properties of new observation (i.e., image) are related to previous observations. Consider a process (such as median) Oᵢ (σₜ₋ₗ², . . . , σₜ₋₁², σₜ²) to filter out outliers from the set of current σᵢ² and previous estimates {σₜ₋₁²}. When ζ_{t-1,t}=1, the accurate estimate should be σᵢ (σₜ₋ᵢ², . . , σₜ₋₁², σₜ²); when ζ_{t-1,t}=0, the accurate estimate is σₜ² itself. So the following linear stabilization is proposed,

σ̅ₜ²=Oᵢ(σₜ₋ᵢ², . . . , σₜ₋₁², σₜ²)·ζ_{t-1,t}+(1−ζ_{t-1,1})·σₜ² (19)

where, σ̅ₜ² is the stabilized final noise variance for frame Iₜ. Note σₜ² in (19) is σₚ² in (15) at time t. The stabilization process in (19) can be performed on both γ and the NLF to get γ and Ω̅ₜ(.).

3.7 Intra-frame Weighting

3.7.1 Noise in Low Frequencies

Image signal is more concentrated in low frequencies, however noise is equally distributed. Down-sampled versus input images cap be exploited to analyze noise in the low frequency components. The variance of finite Gaussian samples follows a scaled chi-squared distribution. But here the computing system utilizes an approximation benefiting the normalized Euclidean distance,

$${ω}_{1} ( l , k ) = exp ( - {C}_{1} \frac{{( {σ}^{2} ( l , k ) - {R}^{2} \cdot {\tilde{σ}}^{2} ( l , k ) )}^{2}}{{( {σ}^{2} ( l , k ) )}^{2}} ) \qquad ( 20 )$$

where exp(.) symbolizes the exponential function, α² and σ² (l, k) are the average of variances of the input and down-sampled patches in the cluster after outlier removal Φ (l, k). The positive constant C₁ (e.g., 0.4) varies depending on the R and the W. Low values of ω₁ (l, k) account for image structure, which the signal is concentrated in low frequencies.

3.7.2 Noise in High Frequencies

The dependency of neighboring pixels is another criterion to extract image structure. The median absolute deviation (MAD) in the horizontal, vertical and diagonal directions expresses this dependency,

τᵢ=median{|Bᵢ(m, n+1)−Bᵢ(m, n)|, Bᵢ(m+1, n)−Bᵢ(m, n)|, |Bᵢ(m+1, n+1)−Bᵢ(m, n)|}, 0≦m, n≦R·W−2 (21)

where τᵢ is the MAD of Bᵢ. For a block of Gaussian samples, with the block size 10≦R·W≦25, σ_{Bi}²=1.1τᵢ. The computing system profits from this property to extract the likelihood function of neighborhood dependency. Assuming for each Φ (l, k), τ (l, k) is the average of τᵢ of the blocks in the Φ (l, k). Under AWGN, the following likelihood function is defined,

$${ω}_{2} ( l , k ) = exp ( - {C}_{2} {R}^{2} \frac{{( {σ}^{2} ( l , k ) - 1.1 {τ}^{2} ( l , k ) )}^{2}}{{( {σ}^{2} ( l , k ) )}^{2}} ) \qquad ( 22 )$$

where C₂=0.2. Low values or ω₂ (l, k) mean a strong neighboring dependency, which is a hint of image structure. In case of white noise, the computing system analyzes the MAD versus variance to estimate if the patch contains structure. Thus, in final estimation step, the computing system uses 1.1 τ² (l, k) instead of σ² (l, k) for patches with structure.

3.7.3 Size of the Cluster

The target patches are more concentrated in homogeneous regions and the size of the homogeneous region should be large enough to precisely represent the noise statistics. Therefore, larger cluster has a higher probability of presenting the homogeneous regions. However, a linear relationship between cluster size and the corresponding weight is not advantageous, since once it is past a certain size, sufficient noise in can be obtained. The following is proposed for with respect to the weight for the size of the cluster,

$${ω}_{3} ( l , k ) = 1 - exp ( - {C}_{3} \frac{N \{ Φ ( l , k ) \}}{N \{ 1 \}} ) \qquad ( 23 )$$

where C₃=80, N{Φ(l, k)} and N{I} are the lumber of patches in Φ(l, k) and the input image, respectively.

3.7.4 Variance of Means and Variance of Variances

In a homogeneous cluster with relatively large number of pixels in each patch, the normalized value of the variance of variances v(l, k)and variance of means ∈(l, k) of {Bᵢ∈Φ(l, k)}, should be small. And so it is proposed,

$$\begin{matrix}{ω}_{4} ( l , k ) = {ω}_{3} ( l , k ) exp ( - {C}_{4} \frac{v ( l , k )}{{σ}^{4} ( l , k )} ) & ( 24 ) \\ {ω}_{5} ( l , k ) - {ω}_{3} ( l , k ) exp ( - {C}_{5} \frac{∈ ( l , k )}{{σ}^{2} ( l , k )} ) & ( 25 )\end{matrix}$$

where

$$v ( l , k ) = \frac{{Σ ( {σ}_{{B}_{i}}^{2} - {σ}^{2} ( l , k ) )}^{2}}{{( N \{ Φ ( l , k ) \} )}^{2} - 1} , \\ ∈ ( l , k ) = \frac{{Σ ( {μ}_{{B}_{i}} - μ ( l , k ) )}^{2}}{{( N \{ Φ ( l , k ) \} )}^{2} - 1}$$

$$and$$

$${C}_{4} = {C}_{5} = 1.$$

In equations (24) and (25) ω₄(l, k) and ω₅(l, k) are directly proportional to ω₃(l, k). Without this, it is probable to assign high values to ω₄(l, k) and ω₅(l, k) when the cluster has a small number of patches even though it is not homogeneous. Uniformity of mean and variance describes cluster homogeneity and leads to high value of ω₄(l, k) and ω₅(l, k).

3.7.5 Intensity Margins

Excluding the intensity extremes from the estimation procedure can be problematic when the signal margins are informative. For instance, the elimination of dark intensities in an underexposed image leads to the removal of the majority of data and, consequently, inaccurate estimation. It therefore herein proposed to use negative weights to margins,

$${ω}_{6} ( l , k ) = - ( \frac{max ( μ ( l , k ) - {I}_{H} , 0 )}{1 - {I}_{H}} + \frac{max ( {I}_{L} - μ ( l , k ) , 0 )}{{I}_{L}} ) \qquad ( 26 )$$

Where I_{H}=0.9 and Iᵢ=0.06

3.7.6 Variance Margins

There are cases where underexposed or overexposed image, parts with very low variances are not observed in the intensity margins. On the other hand, extremely high variances signify image structure. For consumer electronic related applications, the PSNR usually is not below a certain value (e.g., 22 dB). Thus, similar to intensity margins, variance margins also affect the homogeneity characterization. It is therefore proposed to use the following weight,

$${ω}_{7} ( l , k ) = - exp ( - \frac{{σ}^{2} ( l , k )}{{σ}_{min}^{2}} ) - exp ( \frac{δ ( l , k )}{{σ}_{max}^{2}} ) \qquad ( 27 )$$

Where δ(l, κ)=max(σ² (l,k)−σ², 0) σₘᵢₙ²=5 and σₘₐₓ²=200 are variance margins.

3.7.7 Maximum Noise Level

Under PGN, the maximum noise level distinguishes the signal and noise boundary. Hence, the maximum noise level and the corresponding intensity can be used to estimate the NLF. As a result, the Φ(l, k) with the maximum level of the noise should be ranked higher. However, some consideration Should be taken into account in order to exclude clusters containing image structures for this weighting procedure. The basic assumption that noise variance slope is limited helps to restrict the maximum level of noise in each intensity class. So,

σₚₑₐₖ²(l)=min{αₘₐₓmedian[σ²(l, k), max[σ²(l, k)]} (28)

where σₚₑₐₖ (l) is the expected peak of noise in the class l. Assuming η(l, k)=σₚₑₐₖ²(l)−σ²(l, k), by outlining a valid noise variance interval, the weight can be defined as follows (C₈=1),

$${ω}_{8} ( l , k ) = exp ( - {C}_{8} \frac{{η}^{2} ( l , k )}{{σ}^{4} ( l , k )} ) \qquad ( 29 )$$

3.7.8 Clipping Factor

Due to bit-depth limitations, the intensity values of the, input images are clipped in low and high margins. It is proposed to use a weight according to 3σ bound,

$$\begin{matrix}{ω}_{9} ( l , k ) = exp ( - {C}_{9} \frac{{μ}_{clip}^{2}}{{σ}^{2} ( l , k )} ) - 1 ; \\ {μ}_{clip} = max [ μ ( l , k ) + 3 σ ( l , k ) - 1 , 0 ] + max [ μ ( l , k ) - 3 σ ( l , k ) , 0 ]\end{matrix} \qquad ( 30 )$$

where 1 and 0 are maximum and minimum intensity and C₉=0.5. If all pixels are in the 3σ bound, μ_{clip}=0.

3.8 Inter-frame Weighting

Utilizing only spatial data in video signals may lead to estimation uncertainty, especially in processed noise, where the relation between low and high frequency components deviates from AWGN, which in turn makes structure and noise differentiation more challenging. Another issue to consider in video is robust estimation over time especially in joint video noise estimation and enhancement applications.

3.8.1 Temporal Error Weighting

Assume B_{(i,t)} is ith patch in the noisy frame Iₜ at time t, and B_{(i,t+p)} is corresponding patch in the the adjacent noisy frame at time t+p, where p=±1. Based on which adjacent frame (previous or following) has less temporal error for Whole frame p is set to −1 or +1. Assuming the noise level does not change through time the matching (or temporal consistency) factor can he defined as,

$${ω}_{10} ( l , k ) = \sum exp ( - {C}_{10} \frac{{( {σ}_{( {B}_{i , t} )} - {σ}_{( {B}_{i , t + p} )} )}^{2}}{{σ}_{( {B}_{i , t} )}^{2}} ) \qquad ( 31 )$$

where C₁₀=1, B_{(i,t)} ∈ Φₜ (l, k) is the kth connected cluster of class l in Iₜ. Since the homogeneity detection is applied on the input noisy image, there is no guarantee that the temporal B_{(i,t+p)} is also homogeneous. Therefore, high temporal error of few patches should not significantly affect ω₁₀(l, k). For this, the computing system analyzes each patch error and aggregates all matching degrees. This is more reliable than assessing the aggregated variances.

3.8.2 Previous Estimates Weighting

In video applications, noise estimation should be stable through time and coarse noise level jumps are only acceptable when there is a scene (or lighting) change. Therefore, the cluster with the variance closer to previous observation is more likely to be the target cluster. Assuming σₜ₋₁² is the estimated noise σₚ² for the previous frame, the following is defined to add temporal robustness,

$${ω}_{11} ( l , k ) - {ζ}_{t - 1 , t} exp ( ( - {C}_{11} \frac{{[ {σ}_{t - 1} - σ ( l , k ) ]}^{2}}{{σ}_{t - 1}^{2}} ) \qquad ( 32 )$$

where C₁₁=1 and 0≦ζ_{t-1,i}≦1 measures scene change estimated at patch level. Assuming the temporally matched patches have the mean error less than the 2σₘₐₓ²/(W²), the ratio of temporally matched patches to the whole patches defines the ζ_{t-1,t}. Note that (32) guides the estimator to find the most similar homogeneous region in Iₜ₋₁.

3.9 Camera Settings Adaptation

For a specific digital camera, the type and level of the noise can be desirably modeled using camera parameters such as ISO, shutter speed, aperture, and flash on/off. However, creating a model for each camera: requires an excessive data processing. Also such meta-data can be lost for example, due to format conversion and image transferring. Thus, the computing system cannot only rely on the camera or capturing properties to estimate the noise; however, these properties, if available; can support the selection of homogeneous regions and thereby increase estimation robustness. It is assumed the camera settings give probable range of noise level. Patch selection threshold Hₜₕ (l) in (9) can be modified according to this range. The computing system can also use variance margin weights in (27) to reject out of range values.

3.10 User Input Adaptation

In some video applications such as post-production, users require manual intervention to adjust the noise level for their specific needs. Assuming user knowledge about the noise level can define the valid noise range, the variance margin used in (27) can be used to reject the out of range clusters.

4. Experimental Results

The down-sampling rate R is a function of image resolution. For example, R=2 for low resolution (less than 720p) and R=3 for higher resolutions. As a result, noise estimation parameters become resolution independent. In an example embodiment, the down-sampled patch size W is set to 5. The number of classes was set to M=4. This is because a too high number M causes the classes to be too small and their statistics invalid. All constant parameters used in the proposed weights are given and explained directly after their respective equations. The same set of values was used in all the results described herein.

The proposed homogeneous cluster selection can be performed either on one channel of a color space or on each channel separately. Normally the Y channel is less manipulated in capturing process and therefore noise property assumptions in it are more realistic. Observation confirms that adapting the estimation to Y channel leads to better video denoising. Therefore, the estimated target cluster is used in the Y as a guide to select corresponding patches in chroman. Utilizing these patches, the computing system calculates the properties of chroma noise, i.e., γ and according to (15) and (17). Due to space constraint, simulation results here are given for the Y channel.

Target patches in (8) can be recalculated in a second iteration by adapting the \tilde{H}ₘᵢₙ(l) to σₚ² (estimated in first iteration). A finer estimation can be performed by limiting the bound meaning smaller value for αₘₐₓ. The rest of the method is the same as in the first iteration. The complexity of a second iteration is very minor and much less than the first one since patch statistics are already computed. However, tests show that a second iteration improves the estimation results slightly, not justifying iterative estimation.

Next, the performance of the proposed estimation of the NLF, AWGN, PGN, and, PPN has been evaluated separately.

4.1 Additive White Gaussian Noise (AWGN)

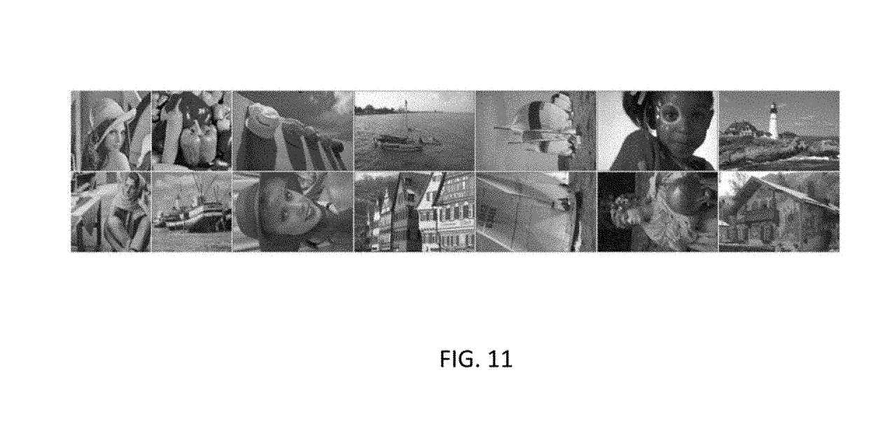

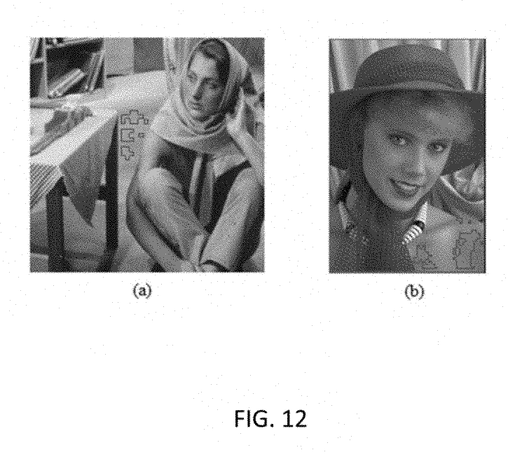

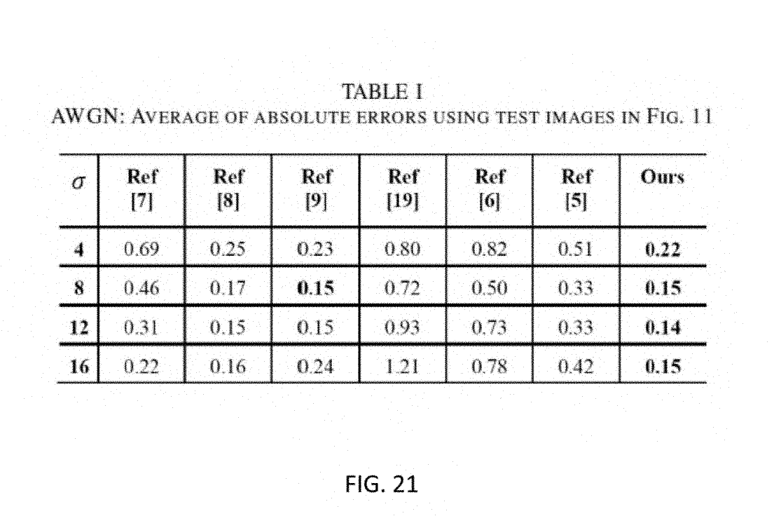

Six state-of-the-art approaches [References 5-9], [Reference 19] are selected and their performance is evaluated on 14 test images as in FIG. 11. Noisy images were generated by adding a zero-mean AWGN to the ground-truth, with 4 levels of standard deviation, from 4 to 16 with the step of 4 and the computing system ran 10 Monte-Carlo experiments for each noise level. Table 1 (see FIG. 21) demonstrates mean of absolute errors of related and proposed method which outperforms. The average variance of the error for our method compared to related methods is similar and is not given here. Method [Reference 8] and [Reference 9] give the closest results. FIG. 12 also shows examples of selected homogeneous clusters.

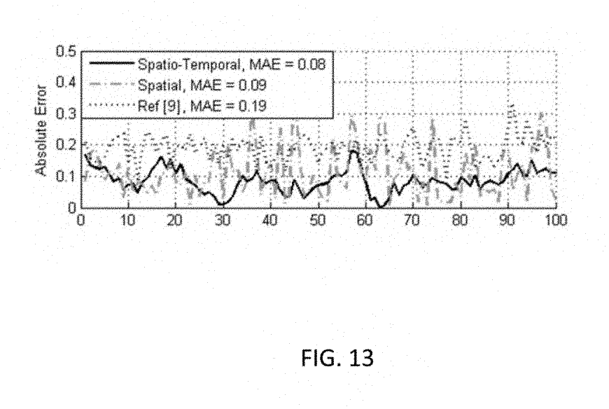

The proposed method in video signals was also tested and FIG. 13 shows average result of noise estimation with and without using temporal data for the first 100 frames of two sequences. Collaboration of inter frame weighting (31), (32) and temporal stabilization (19) improves the estimation. In this figure, a comparison to [9] is shown as closest related work from Table I of FIG. 21.

4.2 Poissonian-Gaussian Noise (PGN)

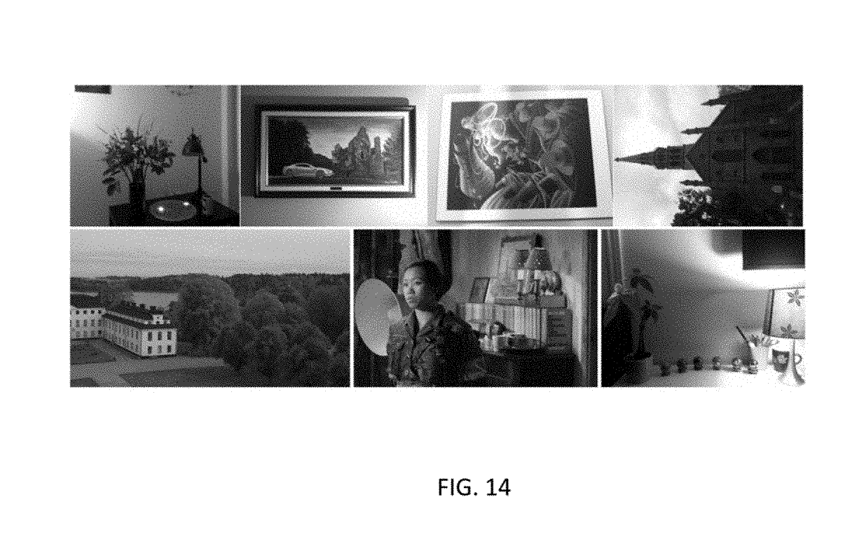

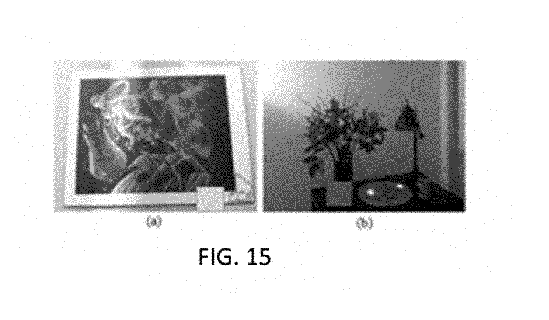

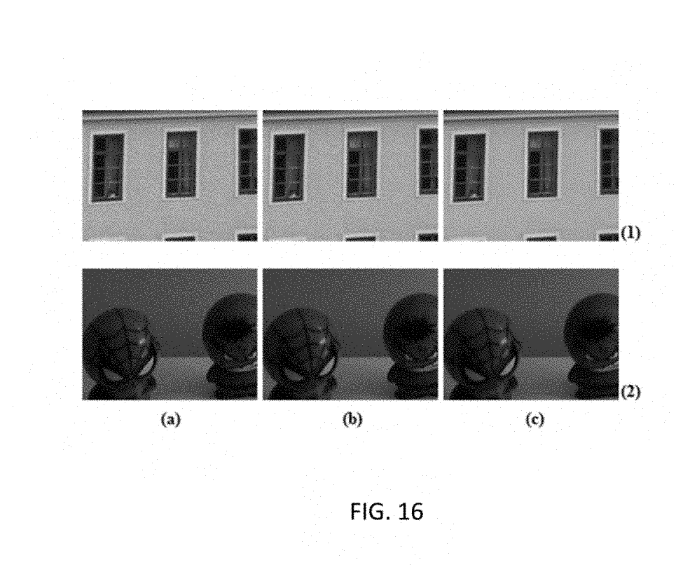

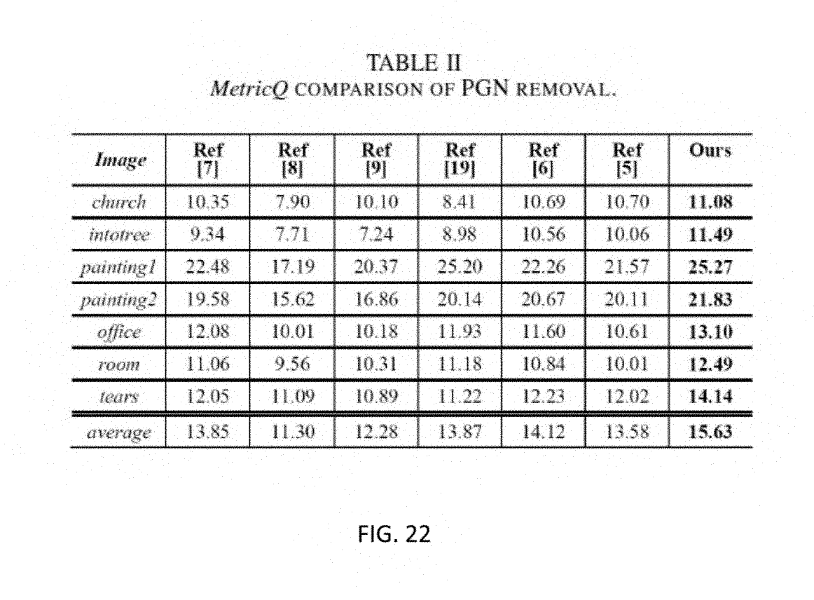

To evaluate the performance of the proposed estimation of PGN, six state-of-the-art approaches [References 5-9, [Reference 19] were tested on seven real world test image. See FIG. 14. In particular, intotree from SVT HD Test Set, tears from Mango Blender and five other real-world noisy images were taken in raw mode, where noise is visibly signal-dependent. To objectively evaluate the PNG estimator without a reference frame, the computing system combined the denoising method BM3D [Reference 31] with noise levels provided from the proposed method and related estimators. The output performance is verified through the no-reference quality index Metric [Reference 32]. Table II (see FIG. 22) compares MetricQ of denoised images with a higher value indicating better quality. The proposed method yields higher quality than related methods, where [Reference 6] and Reference 19] achieve closest results. IVHC avoids underestimation by selecting the cluster with higher variance. FIG. 15 shows examples of selected homogeneous clusters and FIG. 16 shows visual comparison of noisy and noise-reduced image parts. As can be seen, by using IVHC noise is better removed.

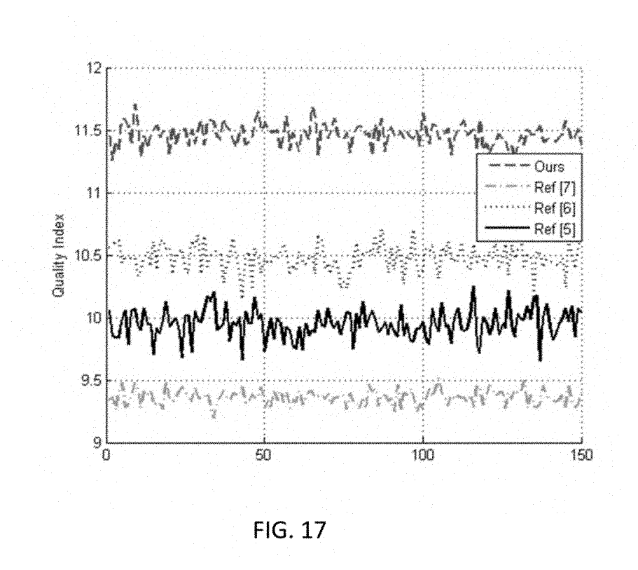

The proposed PGN estimator described herein is also evaluated to denoise video signals using BM3D. FIG. 17 confirms the better quality of our method compared to closest related methods (from Table II) for 150 frames of the intotree sequence.

4.3 Processed Poissonian-Gaussian Noise (PPN)

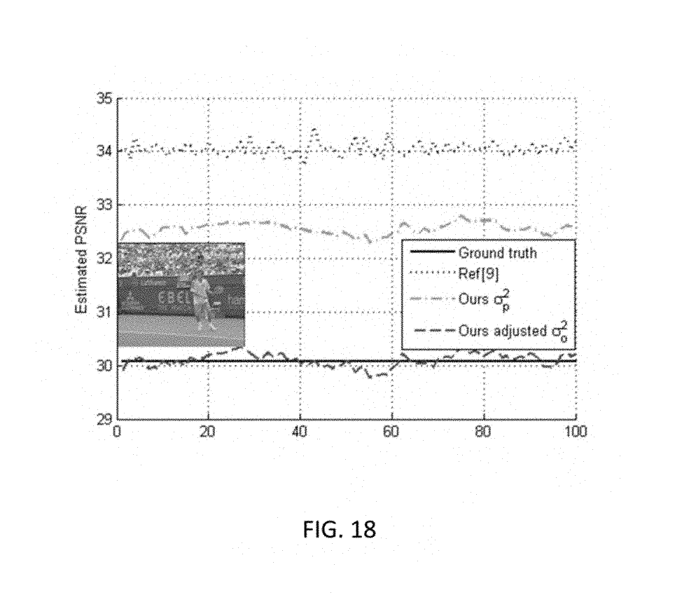

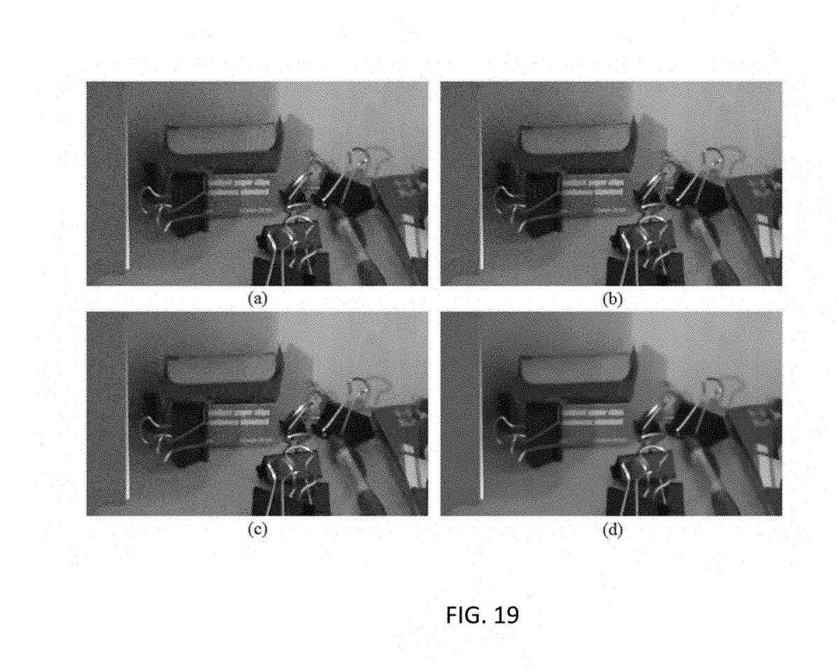

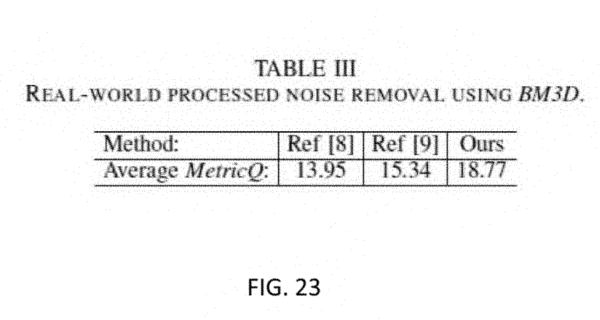

If the observed noise is PPN, downscaling has the effect of converging it to white. This in tarn leads to better patch selection under processed noise. Moreover, since the proposed method uses a large patch size, it leads to include more low frequencies and more realistic estimation. FIG. 18 shows better performance of the proposed method with λ adjustment in (2), and compared to the related method [Reference 9] (which we selected since it is closest to our method under σ=8 in Table I). To evaluate the proposed method under real-world processed noise, 6 images were chosen (4 from iPhone 5 and 2 from iPhone 6) and BM3D [Reference 31] was applied using noise levels provided by [Reference 8, Reference 9], and proposed IVHC. Table III (see FIG. 23) and FIG. 19 show that objectively and subjectively noise is better removed based on IVHC.

4.4 Noise Level Function

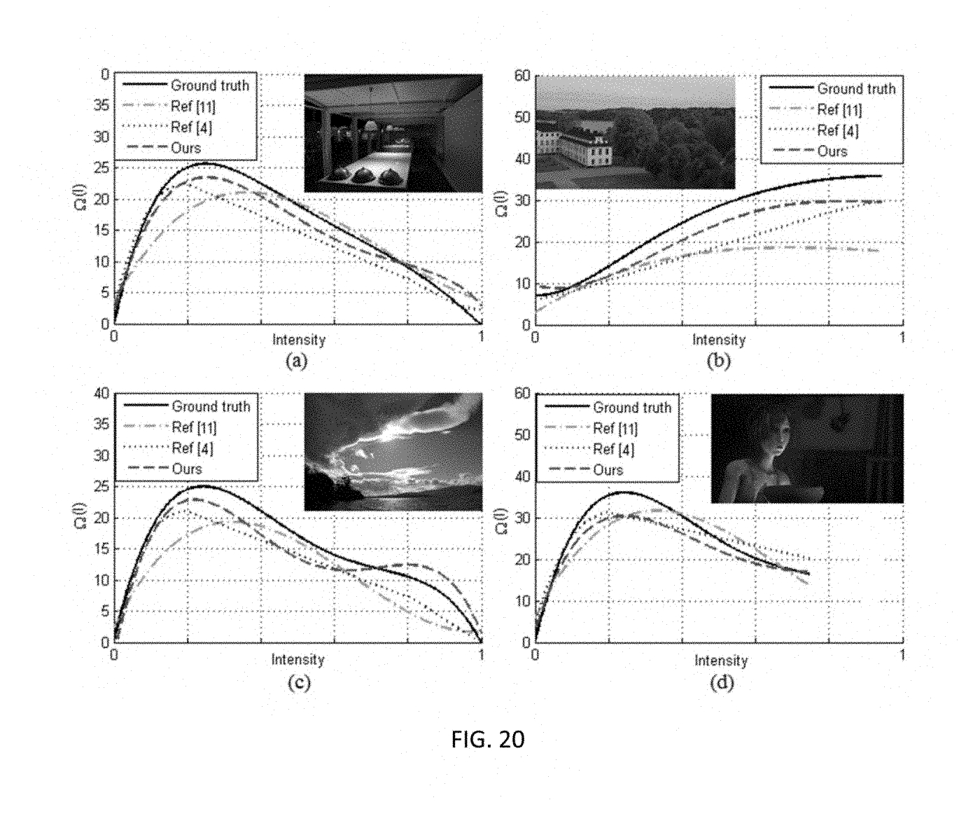

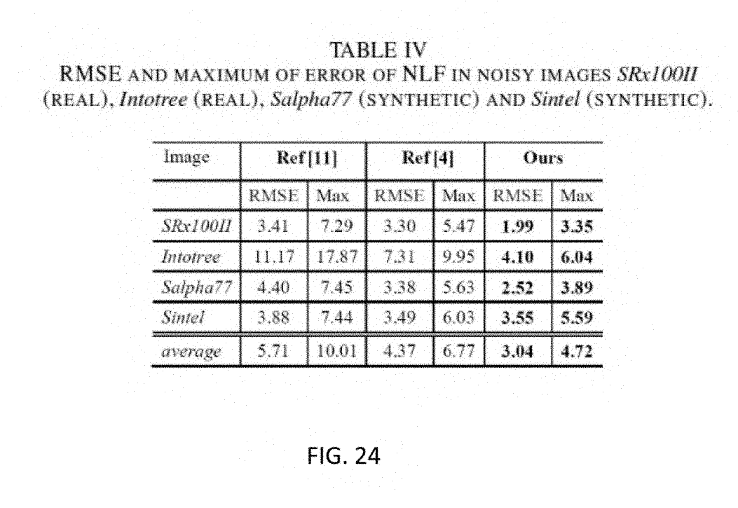

The proposed NLF estimation was applied on images with synthetic and real PGN. The ground-truth for real PGN images has been extracted manually (i.e., subjectively extracted homogeneous regions). Two state-of the-art methods [Reference 11] and [Reference 4] are selected for comparison. FIG. 20 shows NLF results and Table IV (see FIG. 24) shows the root mean squared error (RMSE) and the maximum error comparison. Proposed IVHC has a better performance of finding the noise level peak especially when the level is greater in higher intensities (e.g., Intotree signal).

4.5 Adaptation to Camera Settings and to User Input

The more image information is provided, the more reliable estimation can be performed. Capturing properties if available as a meta-data can be useful for guiding the cluster selection procedure. To test this, 10 highly-textured images taken by a mobile camera were selected (Samsung S5) in the burst mode without motion. First, the ground-truth peak of the noise was manually identified by analyzing the homogeneous patches and temporal difference of burst mode captured images. Second, the proposed noise estimator was applied using only Intra-frame weights and the estimated PSNR when compared the ground truth show an average estimation error of 1.2 dB. In the last step, both the patch selection threshold \tilde{H}ₜₕ(l) in (9) and variance margin weight ω₇(l, k) in (27) were adapted to the meta-data brightness value and ISO. This led to more reliable estimation with average error of 0.34 dB in PSNR.

Performance of image and video processing methods improves if expertise of their users can be integrated. The proposed method easily allows for such integration. For example, if the user of an offline application can define possible noise range, the proposed variance margin (27) can be used to reject the out of range clusters.

5. Conclusion

Noise estimation methods assume visual noise is either white Gaussian or white signal-dependent. The proposed systems and methods bridge the gap between the relatively well studied white Gaussian noise and the more complicated signal-dependent and processed non-white noises. In one aspect of the systems and methods, a noise estimation method is provided that widens the assumptions using vector of weights, which are designed based on statistical property of noise and homogeneous regions in the images. Based on selected homogeneous regions in the different intensity classes, noise level function and processing degree is approximated. It was shown that this visual noise estimation method, robustly handles different type of visual noise: white Gaussian, white Poissonian-Gaussian, and processed anon-white) that are visible in real-world video signals. The simulation results showed better performance of the proposed method both in accuracy and speed.

6. References

The details of the references mentioned above, and shown in square brackets, are listed below. It is appreciated that these references are hereby incorporated by reference.

[Reference 1] R. Szeliski, Computer vision: algorithms and applications, Springer, 2010.

[Reference 2] Y. Tsin, V. Ramesh, and T. Kanade, “Statistical calibration of CCD imaging process,” in Computer Vision ICCV, IEEE Int. Conf. on. IEEE, 2001, vol. 1, pp. 480-487.

[Reference 3] G. E. Healey and R. Kondepudy, “Radiometric CCD camera calibration and noise estimation,” Pattern Analysis and Machine Intelligence, IEEE Trans. on, vol. 16, no. 3, pp. 267-276, March 1994.

[Reference 4] A. Foi, M. Trimeche, V. Katkovnik, and K. Egiazarian, “Practical Poissonian-Gaussian noise modeling and fitting for single-image raw data, ”Image Processing. IEEE Trans. on, vol. 17, no. 10, pp. 1737-1754, 2008.

[Reference 5] M. Ghazal and A. Amer, “Homogeneity localization using particle filters with application to noise estimation,” Image Processing, IEEE Trans. on, vol. 20, no. 7, pp. 1788-1796, 2011.

[Reference 6] J. Tian and Li Chen, “Image noise estimation using a variation-adaptive evolutionary approach,” Signal Processing Letters, IEEE, vol. 19, no. 7, pp. 395-398, 2012.

[Reference 7] Sh.-M. Yang and Sh.-Ch. Tai, “Fast and reliable image-noise estimation using a hybrid approach,” Journal of Electronic Imaging, vol. 19, no. 3, pp. 033007-033007, 2010.

[Reference 8] S. Pyatykh, J. Hesser, and Lei Zheng, “Image noise level estimation by principal component analysis,” Image Processing, IEEE Trans. on, vol. 22, no. 2, pp. 687-699, 2013.

[Reference 9] X. Liu, M. Tanaka, and M. Okutomi, “Noise level estimation using weak textured patches of a single noisy images,” in Image Processing (ICIP), IEEE Int. Conf. on, 2012, pp. 665-668.

[Reference 10] M. Rakhshanfar and A. Amer, “Homogeneity classification for signal dependent noise estimation in images,” in Image Processing (ICIP), IEEE Int. Conf. on, October 2014, pp. 4271-4275.

[Reference 11] Ce Liu, R. Szeliski, S. B, Kang C. L. Zitnick, and W. T. Freeman, “Automatic estimation and removal of noise from a single image,” Pattern Analysis and Machine Intelligence, IEEE Trans. on, vol. 30, no. 2, pp. 299-314, 2008.

[Reference 12] T.-A. Nguyen and M.-Ch. Hong, “Filtering-based noise estimation for denoising the image degraded by Gaussian noise,” in Advances in Image and Video Technology, pp. 157-167, Springer, 2012.

[Reference 13] D.-H. Shin, R.-H. Park, S. Yang, and J.-H. Jung, “Block-based noise estimation using adaptive Gaussian filtering,” Consumer Electronics, IEEE Trans. on, vol. 51, no. 1, pp. 218-226, 2005.

[Reference 14] D. L. Donoho and J. M. Johnstone, “Ideal spatial adaptation by wavelet shrinkage,” Biometrika, vol. 81, no. 3, pp. 425-455, 1994.

[Reference 15] E. J. Balster, Y. F. Zheng, and R. L., Ewing, “Combined spatial and temporal domain wavelet shrinkage algorithm for video denoising,” Circuits and Systems for Video Technology, IEEE Trans. on, vol. 16, no. 2, pp. 220-230, 2006.

[Reference 16] Yang, Y. Wang, W. Xu, and Q. Dai, “Image and video denoising using adaptive dual-tree discrete wavelet packets,” Circuits and Systems for Video Technology, IEEE Trans. on, vol. 19, no. 5, pp. 642-655, 2009.

[Reference 17] M. Hashemi and S. Beheshti, “Adaptive noise variance estimation in Bayes-Shrink,” Signal Processing Letters, IEEE, vol. 17, no, 1, pp. 12-15, 2010.

[Reference 18] H. H. Khalil, R. O. K. Rahmat, and W. A. Mahmoud, “Chapter 15: Estimation of noise in gray-scale and colored images using median absolute deviation (MAD),” in Geometric Modeling and Imaging GMAI, 3rd Int, Conf. on, July 2008, pp. 92-97.

[Reference 19] D. Zoran and Y. Weiss, “Scale invariance and noise in natural images,” in Computer Vision, IEEE 12th Int. Conf. on, September 2009, pp. 2209-2216.

[Reference 20] A. Danielyan and A. Foi, “Noise variance estimation in nonlocal transform domain,” in Local and Non-Local Approximation in Image Processing LNLA, Int. Workshop on, IEEE, 2009, pp. 41-45.

[Reference 21] Sh.-Ch. Tai and Sh.-M. Yang, “A fast method for image noise estimation using Laplacian operator and adaptive edge detection,” in Communications, Control and Signal Processing ISCCSP, 3rd Int. Symposium on, 2008, pp. 1077-1081.

[Reference 22] P. Fu; Q. Sun; Z. Ji; Q. Chen, “A new method for noise estimation in single-band remote sensing images,” Fuzzy Systems and Knowledge Discovery (FSKD), 2012 9th International Conference on, vol., no,. pp. 1664, 1668, 29-31 May 2012.

[Reference 23] A. Foi, “Practical denoising of clipped or overexposed noisy images,” in EUSIPCO, 16th European Signal Processing Conf., 2008, pp. 1-5.

[Reference 24] A Jezierska, C. Chaux, J.-C. Pesquet, Talbot, and G. Engler, “An EM approach for time-variant Poisson-Gaussian model parameter estimation,” Signal Processing, IEEE Trans, on, vol. 62, no. 1, pp. 17-30, January 2014.

[Reference 25] J. Yang, Zh. Wu, and Ch. Hou, “Estimation of signal-dependent sensor noise via sparse representation of noise level functions,” in image Processing (ICIP), 19th IEEE Int. Conf. on, September 2012, pp. 673-676.

[Reference 26] X. Jin, Zh. Xu, and K. Hirakawa, “Noise parameter estimation for Poisson-corrupted images using variance stabilization transforms,” Image Processing, IEEE Trans. on, vol. 23, no. 3, pp. 1329-1339, March 2014.

[Reference 27] A. Kokaram, D. Kelly, H. Denman, and A. Crawford, “Measuring noise correlation for improved video denoising,” in Image Processing (ICIP), 19th IEEE Int. Conf. on, September 2012, pp. 1201-1204.

[Reference 28] M. Colom, M. Lebrun, A. Buades, and J. M. Morel, “A non-parametric approach for the estimation of intensity-frequency dependent noise,” in Image Processing (ICIP), 21th IEEE Int. Conf. on, October 2014.

[Reference 29] P. Perona and Malik, “Scale-space and edge detection using anisotropic diffusion,” Pattern Analysis and Machine Intelligence, IEEE Trans. on, vol. 12, no. 7, pp. 629-639, 1990.

[Reference 30] C. Tomasi and R. Manduchi, “Bilateral altering for gray and color images,” in Computer Vision, Sixth Int. Conf. on, January 1998, pp. 839-846.

[Reference 31] K., Dabov, A. Foi, V. Katkovnik, and. K. Egiazarian, “Image denoising by, sparse 3-D transform-domain collaborative filtering,” Image Processing, IEEE Trans. on, vol. 16, no. 8, pp. 2080-2095, 2007.

[Reference 32] X. Zhu and P. Milanfar, “Automatic parameter selection for denoising algorithms using a no-reference measure of image content,” Image Processing, IEEE Trans. on, vol. 19. no. 12, pp. 3116-3132, 2010.

It will be appreciated that the features of the systems and methods for estimating different types of image and video noise and its level function are described herein with respect to example embodiments. However, these feature§ may be combined with different features and different embodiments of these systems and methods, although these combinations are not explicitly stated.

While the basic principles of these inventions have been described and illustrated herein it will be appreciated by those skilled in the art that variations in the disclosed arrangements, both as to their features and details and the organization of such features and details, may be made without departing from the spirit and scope thereof. Accordingly, the embodiments described and illustrated should be considered only as illustrative of the principles of the inventions, and not construed in a limiting sense.

1. A computer implemented method for estimating noise in at least one of an image and a video feed, the method comprising:
down sampling an input frame from the image and video feed to generate a down-sampled frame;
separating the down-sampled frame into non-overlapping patches, each patch associated with an intensity;
clustering the non-overlapping patches based on predefined visual attributes associated with each patch;
selecting a cluster with a highest homogeneity from the clusters;
utilizing the selected cluster for estimating noise in the image and video feed.

2. The method of claim 1, wherein estimating the noise in the image and video feed comprises determining a peak noise variance and a processing degree, the method further comprising generating a noise level function based on the peak noise variance.

3. The method of claim 2, further comprising using the peak noise variance, the processing degree, and the noise level function to perform a stabilization.

4. The method of claim 1, wherein the attributes are selected from the group comprising: intensity, spatial relation, low-high frequency relation, size, rejection of extreme image margins, and temporal information.

5. The method of claim 1, wherein the noise is selected from at least one of white Gaussian, Poissonian-Gaussian, and processed non-white noise.

6. The method of claim 1, wherein the step of clustering further comprises removing a pre-defined number of outlier patches based on intensity levels.

7. The method of claim 2, wherein the noise level variance and the noise level function of the signal are estimated based upon the selected cluster.

8. The method of claim 1, wherein estimating noise farther comprises associating a noise variance associated with the selected duster with a peak noise variance in the signal.

9. The method of claim 1, further comprising performing a linear stabilization process according to: σ̅ₜ²=Oᵢ(σₜ₋ᵢ², . . . , σₜ₋₁², σₜ²)·ζ_{t-1.t}+(1−ζ_{t-1,t})·σₜ²; where ζ_{t-1,t} represents the similarity between the current Iₜ and previous frame Iₜ₋₁; 0≦ζ_{t-1,t}≦1, and where, σ̅ₜ² is the stabilized final noise variance for frame Iₜ.

10. A computer readable medium comprising computer executable instructions for estimating noise in at least one of an image and a video feed, the computer readable medium comprising computer executable instructions for:
down,sampling an input frame from the image and video feed to generate a down-sampled frame;
separating the down-sampled frame into non-overlapping patches, each patch associated with an intensity;
clustering the non-overlapping patches based on predefined visual attributes associated with each patch;
selecting a cluster with a highest homogeneity from the clusters; and
utilizing the selected cluster for estimating noise in the image and video feed.

11. A computer system for estimating noise in at least one of an image and a video feed, the computing system comprising:
a processor;
memory configured to store executable instructions and the at least one of the image and the video feed;
the processor configured to at least:
down-sample an input frame from the image and video feed to generate a down-sampled frame;
separate the down sample:: frame into non-overlapping patches, each patch associated with an intensity;
cluster the non-overlapping patches based on predefined visual attributes associated with each patch;
select a cluster with a highest homogeneity from the clusters; and
utilize the selected cluster for estimating noise in the image and video feed.

12. The computer system of claim 11, wherein estimating the noise in the image and video feed comprises determining a peak noise variance and a processing degree, the method further comprising generating a noise level function based on the peak noise variance.

13. The computer system of claim 12, further comprising a stabilizer configured for using the peak noise variance, the processing degree, and the noise level function to perform a stabilization.

14. The computer system of claim 11, wherein the visual attributes are selected from the group comprising: intensity, spatial relation, low-high frequency relation, size, rejection of extreme image margins, and temporal information.

15. The computer system of claim 11, wherein the noise is selected from at least one of: white Gaussian, Poissonian-Gaussian, and processed noise.

16. The computer system of claim 11, wherein the clustering further comprises removing a pre-defined number of outlier patches based on in levels.

17. The computer system of claim 12, wherein the noise level variance and the noise level function of the signal arc estimated based upon the selected cluster.

18. The computer system of claim 11, wherein estimating noise further comprises associating a noise variance associated with the selected cluster with a peak noise variance in the signal.

19. The computer system of claim 11 comprising a body that houses the processor, the memory and a camera device configured to capture the at least one of the image and the video feed.

20. The computer system of claim 11, wherein the processor is further configured to: perform a linear stabilization process according to: σ̅ₜ²=Oₒ(σₜ₋ᵢ², . . . , σₜ₋₁², σₜ²)·ζ_{t-1,t}+(1−ζ_{t-1,t})·σₜ²; where ζ_{t-1,t} represents the similarity between the current Iₜ and previous frame Iₜ₋ₗ; 0≦ζ_{t-1,t}≦1, and where, σ̅ₜ² is the stabilized final noise variance for frame Iₜ.
